(19) United States
(12) Patent Application Publication
(10) Pub. No.: US 2022/0232847 A1
(43) Pub. Date: Jul. 28, 2022

(54) COFFEE COMPOSITION AND PROCESS

(71) Applicant: SOCIETE DES PRODUITS NESTLE S.A., Vevey (CH)

(72) Inventors: Kevan Arthur Elsby, Orbe (CH); Christian Milo, Savigny (CH); Sean Mackay Murphy, Cossonay-Ville (CH); Luigi Poisson, Courgevaux (CH); Tomas Davidek, Correvon (CH); Stefan Spreng, Orbe (CH)

(21) Appl. No.: 17/603,651

(22) PCT Filed: Apr. 1, 2020
(86) PCT No.: PCT/EP2020/059256

§ 371 Date: Oct. 14, 2021

(30) Foreign Application Priority Data
Apr. 17, 2019 (EP) 19169747.3
Jul. 11, 2019 (RU) 2019121839

(51) Int. Cl. A23F 5/04; A23F 5/28; A23F 5/36

(52) U.S. Cl. CPC A23F 5/04; A23F 5/36; A23F 5/28

(57) ABSTRACT

The present invention relates to a coffee composition with improved aroma and a method of producing a coffee composition wherein two different types of coffee beans are roasted separately.

### FIELD OF THE INVENTION

The present invention relates to a coffee composition with improved aroma and a method of producing a coffee composition wherein two different types of coffee beans are roasted separately.

### BACKGROUND

The characteristic aroma and taste of coffee is developed during the roasting of the coffee beans and the degree of roasting impacts the character of the aroma. The degree of roasting can most conveniently be determined by the roast colour of the beans, which during roasting develops from the light greenish colour of raw unroasted beans to a darker brownish or even black colour characteristic of roasted coffee beans. A low degree of roasting is normally associated with higher perceived acidity and more fruity and winey aroma notes, whereas a high degree of roasting develops more roasty notes and lower perceived acidity. It is known from the WO 01/67880 (The Procter & Gamble Company) that a more balanced flavour in roast and ground coffee intended for traditional brew coffee can be achieved by the combination of coffee beans that have been roasted to different degrees as measured by the roast colour of the beans. The combination of a so-called “faster-roast fraction” of coffee beans roasted to a darker roast colour and a “slower-roast fraction” roasted to a lighter roast colour was shown to lead to a more balanced flavour profile, however WO 01/67880 also teaches that the difference in roast colour between any slower-roast fraction and any faster-roast fraction should be small to achieve the desired balanced flavour profile, specifically, the difference in degree of roast colour should not be more than 2 L on the Hunter L scale, when the faster-roast fraction is Arabica beans.

However, the present inventors have found that when the combination of a faster-roast fraction of Arabica beans with a slower-roast fraction of Robusta beans with a colour difference of about 2 L is used to produce a soluble coffee, no significant improvement of the flavour profile is found in a coffee beverage prepared from the soluble coffee product. Accordingly, there is still a need for improved coffee compositions which exhibit a fuller and more balanced aroma profile.

### SUMMARY OF THE INVENTION

The present inventors have found that when combining lighter roast beans of one type (such as Arabica beans) with darker roast beans of a second type (such as Robusta beans), for example to produce a coffee to be used for a soluble coffee product, the colour difference between the two types of beans must be large, compared to the teaching of the prior art, to achieve a significant improvement of the flavour profile of the coffee beverage. The coffee composition produced has a balanced content of aroma compounds related to roasty aroma notes such as furfural and fruity smelling compounds such as (E)-β-damascenone.

Accordingly, the present invention relates to a coffee composition comprising furfural and (E)-β-damascenone wherein the ratio of concentrations of furfural to (E)-β-damascenone is from 400 to 1000. In a further aspect, the invention relates to a method of producing a coffee composition, the method comprising; a) roasting a first type of green coffee beans to a roast colour of between 60 and 120 CTN; b) roasting a second type of green coffee beans to a roast colour of between 30 and 100 CTN; c) optionally, extracting the roasted beans obtained in step a) and the roasted beans obtained in step b) with water; wherein the roast colour of the roasted beans obtained in step a) is at least 20 CTN higher than the roast colour of the roasted beans obtained in step b), and the second type of beans are roasted for a period at least 5 minutes longer than the period for which the first type of beans are roasted; and wherein the first type of green coffee beans is from a different origin and/or a different coffee species than the second type of green coffee beans.

### DETAILED DESCRIPTION OF THE INVENTION

The present invention relates to a coffee composition. The coffee composition may be selected from the group consisting of soluble coffee product, roast and ground coffee, a liquid coffee extract and a packaged ready-to-drink coffee. A soluble coffee product is a product comprising soluble coffee solids being suitable for preparation of a coffee beverage. A soluble coffee product may be in dry form, e.g. as a powder, e.g. a spray or freeze dried powder, which can be used for the preparation of a coffee beverage by dissolution in a liquid such as water and/or milk. A soluble coffee product may comprise additional ingredients such as milk, milk components, creamer, sugar, sweetener, flavouring, buffers, and the like. Roast and ground coffee is formed by roasting green coffee beans and grinding them. Green coffee beans are raw, unroasted coffee beans. Roast and ground coffee has been used for many years to prepare coffee by brewing with water. A liquid coffee extract may be in the form of a liquid concentrate which is suitable for preparation of a coffee beverage by dilution with an aqueous liquid. A ready-to-drink (RTD) coffee is a liquid product suitable for direct consumption, it may comprise other ingredients in addition to coffee such as dairy or non-dairy creamer and sugar. In an embodiment, the coffee composition comprises (for example consists) on a dry basis of components from roasted coffee, milk components and sweetener components. In an embodiment, the coffee composition comprises (for example consists) on a dry basis of components from roasted coffee.

In an embodiment the coffee composition is a liquid coffee extract comprising at least 1.5% by weight of coffee solids, or a dried coffee extract. Coffee solids are compounds, excluding water, obtained from coffee, for example roasted coffee. Soluble coffee solids are water-soluble compounds which have been extracted from coffee beans, typically using water and/or steam. Methods for extraction of soluble solids from coffee beans are well known in the art of soluble coffee production and any suitable method may be used.

The inventors have found that a coffee composition with superior flavour and aroma quality can be produced from roasted high quality beans with intrinsic fruity/floral aroma and fine acidity (such as good quality Arabica beans) combined with a different type of beans being lower quality beans when the different types of coffee beans are roasted to different roast colours. The roasting conditions used impact the balance of aroma and taste active chemistry. For example, roasting Arabica beans to low CTN values will tend to lead to degradation of aroma compounds related to buttery and roasty aroma notes such as 2,3-pentanedione. Roasting Robusta beans to a low CTN values favours the formation of phenolic, smoky aroma notes such as 4-ethylguaiacol. In addition to the roasting colour, the inventors were surprised to discover that the time of roasting played an important role, independent of the roasting colour achieved. Roasting Robusta more slowly than Arabica amplifies the beneficial effects of roasting Robusta to a lower roasting colour. The product of the invention is characterised by a full bodied aroma profile comprising both fruity and winey as well as roasty aroma notes. Compared to existing coffee compositions, the products of the invention are characterised by a content of aroma compounds related to buttery and roasty aroma notes such as 2,3-pentanedione and furfural, in balance with the content of aroma compounds related to phenolic, smoky aroma notes such as 4-ethylguaiacol, and fruity smelling compounds such as (E)-β-damascenone.

An aspect of the invention provides a coffee composition comprising furfural and (E)-β-damascenone wherein the ratio of concentrations of furfural to (E)-β-damascenone is from 400 to 1000, for example from 410 to 600, for further example from 420 to 550. The concentrations used to calculate the ratio of concentrations may for example be in terms of the mass of the aroma compound divided by the mass of soluble coffee solids in the coffee composition. For example the ratio of concentrations of furfural to (E)-β-damascenone may be calculated as a ratio of the concentration of furfural in mg of aroma compound per kg of soluble coffee solids to the concentration of (E)-β-damascenone in mg of aroma compound per kg of soluble coffee solids.

The aroma compounds 2,3-pentanedione and 4-ethylguaiacol are important contributors to the overall coffee aroma and are strongly influenced by the roasting conditions. Both compounds should be present in the right balance to have an equilibrium of smooth coffee notes on one hand, and roasty character on the other side. Therefore, roasting at least two types of coffee beans according to the method of the invention best leverages the individual characteristics inherent to the varieties used. In an embodiment, the coffee composition comprises 4-ethylguaiacol and 2,3-pentanedione wherein the ratio of concentrations of 2,3-pentanedione to 4-ethylguaiacol is from 5 to 20, for example 5.5 to 10. The concentrations used to calculate the ratio of concentrations may for example be in terms of the mass of the aroma compound in the coffee composition. The mass of the aroma compound present may be measured using gas chromatography mass spectrometry, for example using isotopically labelled standards in conjunction with solid phase microextraction and gas chromatography-mass spectrometry (SPME-GC-MS/MS) analysis. Clearly, as long as the denominator used for the concentration fraction of both compounds is the same, the ratio of concentrations is also the ratio of the mass of aroma compounds present. For example the ratio of concentrations of 2,3-pentanedione to 4-ethylguaiacol may be calculated as a ratio of the concentration of 2,3-pentanedione in mg of aroma compound per kg of soluble coffee solids to the concentration of 4-ethylguaiacol in mg of aroma compound per kg of soluble coffee solids.

The products of the invention are further characterised by balanced proportions of 4-ethylguaiacol and the astringent taste compound N-caffeoyl-tryptophan. N-caffeoyl-tryptophan is the most abundant representative of the group of cinnamoyl-amino acid conjugates (conjugated amides). This component is a typical marker for green Robusta coffee beans, which steadily decreases throughout the roasting course. Consequently, roasting Robusta to a lower roasting colour potentially reduces the astringency of the product. In addition, the degradation of the class of conjugated amides is associated with the reduction of the typical rubbery characteristic of Robusta beans, and hence a lower roasting colour is beneficial to be applied for Robusta beans only, without compromising on the Arabica quality.

In an embodiment the coffee composition comprises N-caffeoyl-tryptophan and 4-ethylguaiacol wherein the ratio of concentrations of 4-ethylguaiacol to N-caffeoyl-tryptophan is from 1500 to 3000, for example from 1700 to 2800. The quantity of N-caffeoyl-tryptophan may be expressed as rosmarinic acid equivalent. For example the ratio of concentrations of 4-ethylguaiacol to N-caffeoyl-tryptophan may be calculated as a ratio of the concentration of 4-ethylguaiacol in mg of aroma compound per kg of soluble coffee solids to the concentration of N-caffeoyl-tryptophan in mg of compound expressed as rosmarinic acid equivalent per kg of soluble coffee solids.

The inventors have found that a coffee composition with superior flavour and aroma quality can for example be produced from roasted Arabica and Robusta coffee beans. In an embodiment the coffee composition comprises at least 20 wt. % coffee solids originating from Robusta beans as a percentage of total coffee solids, for example at least 20 wt. % soluble coffee solids originating from Robusta beans as a percentage of total soluble coffee solids. The coffee composition may comprise coffee solids consisting of coffee solids originating from Robusta and Arabica beans. The coffee composition may comprise from 20 and 80 wt. % coffee solids originating from Robusta beans as a percentage of total coffee solids, for example from 20 and 80 wt. % soluble coffee solids originating from Robusta beans as a percentage of total soluble coffee solids. The composition of beans in a coffee blend may for example be determined using near infra-red (NIR) techniques, or the level of markers such as mozambiozide.

Coffee beans are the seeds of the coffee plant (Coffea). By Arabica coffee beans are meant coffee beans from Arabica coffee plants (Coffea arabica) and by Robusta coffee beans are meant beans from Robusta coffee plants (Coffea canephora). Arabica and Robust coffee beans are examples of different coffee species.

2,3-butanedione is an aroma compound responsible for buttery aroma notes. The coffee composition of the invention may comprise at least 45 mg of 2,3-butanedione per kg of soluble coffee solids, for example at least 48 mg of 2,3-butanedione per kg of soluble coffee solids, for further example at least 50 mg of 2,3-butanedione per kg of soluble coffee solids. The coffee composition of the invention may comprise between 45 and 65 mg of 2,3-butanedione per kg of soluble coffee solids The coffee composition of the invention may comprise at least 3.0 mg of 4-ethylguaiacol per kg of soluble coffee solids, for example at least 3.5 mg of 4-ethylguaiacol per kg of soluble coffee solids. The coffee composition of the invention may comprise between 3.5 and 5.5 mg of 4-ethylguaiacol per kg of soluble coffee solids. The coffee composition of the invention may comprise at least 20 mg of 2,3-pentanedione per kg of soluble coffee solids, for example at least 23 mg of 2,3-pentanedione per kg of soluble coffee solids. The coffee composition of the invention may comprise between 20 and 30 mg of 2,3-pentanedione per kg of soluble coffee solids, for example between 23 and 27 mg of 2,3-pentanedione per kg of soluble coffee solids. The coffee composition of the invention may comprise between 6000 and 12000 mg of N-caffeoyl-tryptophan expressed as rosmarinic acid equivalent per kg of soluble coffee solids, for example between 7500 and 10000 mg of N-caffeoyl-tryptophan expressed as rosmarinic acid equivalent per kg of soluble coffee solids. The coffee composition of the invention may comprise at least 35 mg of furfural per kg of soluble coffee solids. The coffee composition of the invention may comprise between 35 and 50 mg of furfural per kg of soluble coffee solids. The coffee composition of the invention may comprise between 0.05 and 0.12 mg of (E)-β-damascenone per kg of soluble coffee solids, for example between 0.08 and 0.11 mg of (E)-β-damascenone per kg of soluble coffee solids.

In a further aspect, the invention provides a method of producing a coffee composition, the method comprising;

a) roasting a first type of green coffee beans to a roast colour of between 60 and 120 CTN;

b) roasting a second type of green coffee beans to a roast colour of between 30 and 100 CTN;

c) optionally, extracting the roasted beans obtained in step a) and the roasted beans obtained in step b) with water;

wherein the roast colour of the roasted beans obtained in step a) is at least 20 CTN higher than the roast colour of the roasted beans obtained in step b), and the second type of beans are roasted for a period at least 5 minutes longer than the period for which the first type of beans are roasted; and wherein the first type of green coffee beans is from a different origin and/or a different coffee species than the second type of green coffee beans.

The first type of green coffee beans may be high quality beans with an intrinsic fruity/floral aroma and a fine acidity. The second type of green beans, being from a different origin and/or a different coffee species than the first type of green coffee beans may be of a lower quality grade than the first type of green coffee beans. The second type of green coffee beans may for example be dry processed Robusta or dry processed Brazilian Arabica beans. By “different origin” is meant that the beans are grown in a different geographical region or country. Colombian, Kenyan, Costa Rican, Nicaraguan and Brazilian are examples of origins. The first type of green coffee beans may be selected from the group consisting of Colombian Arabica, Kenyan Arabica, Central American Arabica (for example Costa Rican or Nicaraguan), high quality Brazilian Arabica, highest quality Robusta and combinations of these. For example the first type of green coffee beans may be selected from the group consisting of Colombian Arabica, Kenyan Arabica, Central American Arabica (for example Costa Rican or Nicaraguan), high quality Brazilian Arabica and combinations of these. For further example the first type of green coffee beans may be Colombian Arabica or Kenyan Arabica. In an embodiment the first type of green coffee beans are beans selected from the group consisting of Colombian Arabica, Kenyan Arabica, Costa Rican Arabica, Nicaraguan Arabica coffee beans and combinations of these.

The first type of green coffee beans may be Arabica and the second type of beans may be Robusta. In an embodiment, the method of producing a coffee composition comprises;

a) roasting green Arabica coffee beans to a roast colour of between 60 and 120 CTN;

b) roasting green Robusta coffee beans to a roast colour of between 30 and 100 CTN;

c) optionally, extracting the roasted Arabica beans obtained in step a) and the roasted Robusta beans obtained in step b) with water (for example to produce aqueous coffee extracts that may be further processed into pure soluble coffee);

wherein the roast colour of the roasted Arabica coffee beans is at least 20 CTN higher than the roast colour of the roasted Robusta beans, and the green Robusta beans are roasted for a period at least 5 minutes longer than the period for which the green Arabica beans are roasted.

By roasting is meant a heat treatment of coffee beans performed to develop the typical flavour and aroma of roasted coffee as well as darkening the colour of the beans. Roasting according to the invention may be performed by any suitable method known in the art. Conventionally, roasting is usually performed by heating the coffee beans with hot air. The heating of the bean leads to evaporation of water and as the temperature rises inside the beans, chemical reactions take place, including Maillard reactions, the typical aroma and flavour compounds characterising roasted coffee are formed and the colour of the beans becomes darker. The temperature of the coffee beans typically reach between about 170° C. and about 260° C. during roasting. The roasting time typically varies between about 1 minute and about 30 minutes. The degree of roasting applied depends on the desired aroma and flavour characteristics of the beans.

Roasting degree can be determined by roast bean colour, ranging from light to dark (or extra dark), each of the colour levels being associated with a different flavour profile. Light roasts are light brown in colour, with a light body and no oil on the surface of the beans. Light roast have usually a toasted taste and pronounced acidity. Light roasted beans usually reach product temperatures between 180° C. to 205° C. during roasting. Medium roasted coffee are medium brown in colour with more body that light roasts, with no oil in the surface of the bean. Medium roast exhibits more balanced flavour, aroma and acidity. Medium roasted coffee beans usually reach product temperatures between 210° C. and 220° C. during roasting. Medium to dark roasts have a darker colour with some oil beginning to show on the surface of the beans. Medium to dark roasted beans have a heavy body in comparison with the light or medium roasts. Flavours and aromas of roasting are more pronounced. The medium to dark roasted beans usually reach an internal temperature of about 225° C.-230° C. during roasting. Finally, extra dark roasts are dark brown in colour or sometimes even almost black. The beans have a sheen of oil on the surface, which is usually is usually visible in the cup when extra dark coffee is brewed. Extra dark roasted coffee beans have usually a bitter, smoky or even burnt taste and is characterized by flavour of tar and charcoal. Extra dark roasted coffee beans usually reach product temperatures exceeding 240° C. during roasting.

Roast bean colour may be expressed in CTN units. CTN roast colour may vary between 0 and 200 and is determined by measuring the intensity of Infrared (IR) light (904 nm) that is back scattered by the sample when measured with a spectrophotometer, such as Neuhaus Neotec' s ColorTest II®. The spectrophotometer illuminates the surface of the ground sample with monochromatic IR light at a wavelength of 904 nm from a semi-conductor source. A photo-receiver, which has been calibrated, measures the amount of light reflected by the sample. The mean value series of measurement is calculated and displayed by electronic circuit. The colour of the coffee beans is directly related to its roast level. For example, green coffee beans have typically a CTN of above 200, extremely lightly roasted coffee beans have typically a CTN of around 150, lightly roasted coffee beans have typically a CTN around 100 and medium-dark coffee beans have typically a CTN of around 70. Very dark roasted coffee beans have typically a CTN around 45.

Roast colour may also be expressed as “Hunter L-colour” using a Hunter Colorimeter, as described e.g. in WO 01/67880 (The Procter & Gamble Company) and references indicated therein. The present inventors have determined the correlation between colour as expressed in CTN units and Hunter L-colour units, this is described in Example 1 below and allows conversion between the units.

In an embodiment of the present invention, a first type of green coffee beans, for example green Arabica coffee beans, are roasted to a roast colour of between 65 and 110 CTN, for example between 70 and 100 CTN in step a) of the method of the invention. In another embodiment of the present invention, a second type of green coffee beans, for example green Robusta coffee beans, are roasted to a roast colour of between 35 and 80 CTN, for example between 40 and 65 CTN in step b) of the method of the invention. In yet another embodiment, the roast colour of the roasted first type of coffee beans (for example Arabica coffee beans) is at least 25, 30 or 35 CTN higher than the roast colour of the roasted second type of coffee beans (for example Robusta coffee beans). In a further embodiment, a first type of green coffee beans (for example green Arabica coffee beans) are roasted to a roast colour of between 70 and 100 CTN in step a) and a second type of green coffee beans (for example green Robusta coffee beans) are roasted to a roast colour of between 35 and 65 CTN, in step b) of the method of the invention and the roast colour of the roasted first type of coffee beans (for example Arabica coffee beans) is at least 25 CTN higher than the roast colour of the roasted second type of coffee beans (for example Robusta beans). In a still further embodiment, a first type of green coffee beans (for example green Arabica coffee beans) are roasted to a roast colour of between 80 and 110 CTN in step a) and a second type of green coffee beans (for example green Robusta coffee beans) are roasted to a roast colour of between 55 and 65 CTN, in step b) of the method of the invention and the roast colour of the roasted first type of coffee beans (for example Arabica coffee beans) is at least 35 CTN higher than the roast colour of the roasted second type of coffee beans (for example Robusta coffee beans). Degree of roasting, e.g. as expressed in terms of roast colour, depends e.g. on temperature and time of roasting.

In an embodiment, the first type of green coffee beans (for example green Arabica beans) are roasted for a period of between 1 and 10 minutes in step a), for example between 1.5 and 7.5 minutes. For example the first type of green coffee beans (for example green Arabica beans) may be roasted for a period of between 1 and 10 minutes in step a) (for example between 1.5 and 7.5 minutes) by being exposed to temperatures above about 150° C. In an embodiment, the second type of green coffee beans (for example green Robusta beans) are roasted for a period of between 6 and 20 minutes in step b), for example between 8 and 20 minutes, for further example between 9 and 16 minutes. For example the second type of green coffee beans (for example green Robusta beans) may be roasted for a period of between 6 and 20 minutes in step b) (for further example between 8 and 20 minutes, for further example between 9 and 16 minutes) by being exposed to temperatures above about 150° C.

In an embodiment, the first type of green coffee beans (for example green Arabica coffee beans) constitute between 20% and 80% by weight of the total amount of green coffee beans subjected to the method of the invention. For example, the first type of green coffee beans (for example green Arabica coffee beans) may constitute between 30% and 70% by weight of the total amount of green coffee beans subjected to the method of the invention. In one embodiment of the invention wherein the first type of green coffee beans is Arabica and the second type of green coffee beans is Robusta, part of the Arabica coffee beans, e.g. 10-30%, are roasted together with Robusta coffee beans.

The roasted beans obtained in step a) and the roasted beans obtained in step b) may be extracted with water (for example to produce aqueous coffee extracts that may be further processed into pure soluble coffee). By extraction with water is meant that the coffee beans are extracted with purified water, tap water, and/or another aqueous liquid such as e.g. an aqueous coffee extract. Extraction may be performed by any suitable method known in the art. Methods for extracting coffee beans are well known in the art of production of soluble coffee, e.g. from EP 0826308, and normally involves several extraction steps at increasing temperature. In a preferred embodiment, extraction of roast coffee beans is performed at a temperature of between 140° C. and 300° C., whereby is meant that the extraction temperature reaches a temperature of at least 140° C. during the extraction although parts of the extraction may be performed at lower temperatures, and that the temperature during extraction at no point exceeds 300° C. When the desired degree of extraction has been reached, the extracted roast coffee beans are separated from the extract. The separation may be achieved by any suitable means, e.g. filtration, centrifugation, and/or decanting. In conventional coffee extraction for the production of soluble coffee, the separation is usually achieved by performing the extraction in extraction cells wherein the coffee grounds are retained by filter plates or retainer plates through which the coffee extract can flow. Before and/or during extraction, volatile aroma compounds may be recovered from the coffee beans and/or the extract, e.g. by steam stripping and/or the use of vacuum, to avoid loss of aroma. The recovered volatile compounds may be added back to the extract after extraction. Methods for aroma recovery and add-back are well known in the art of soluble coffee production.

The roasted beans obtained in step a) and/or the roasted beans obtained in step b) are preferably ground before being extracted with water (for example to produce aqueous coffee extracts that may be further processed into pure soluble coffee). Grinding of roasted coffee beans are well known in the art and the roasted coffee beans may be ground by any suitable method.

The roasted beans obtained in step a) and the roasted beans obtained in step b) may be mixed before the extraction in step c), such that they are extracted together to produce a single coffee extract. However, it is preferred that the roasted beans obtained in step a) and/or the roasted beans obtained in step b) are extracted separately in step c) to obtain two separate coffee extracts which are subsequently mixed. In this way it is possible to adapt the extraction conditions, e.g. by taking the chemical composition and aroma characteristics of each portion into account, to obtain the desired composition and extraction yield from each portion of roasted coffee beans and in the final mixed coffee extract.

A coffee composition obtained by the method of the invention being a liquid coffee extract may be packed directly into cans or bottles to be sold for direct consumption as a so-called RTD (Ready to Drink) coffee product. It may also be subjected to various processing steps such as pasteurisation, sterilisation, and/or concentration, before being filled into the final packaging, and additional ingredients may be added depending on the desired product, e.g. milk, milk components, creamers, sugars, sweeteners, flavours, buffers, and the like.

In an embodiment, the extract(s) obtained in step c) is/are dried to produce a dry soluble coffee product. Drying may be performed by any suitable method known in the art, such as e.g. spray drying or freeze drying. The liquid coffee extract(s) may be concentrated, e.g. by evaporation, before being dried. If the roasted beans obtained in step a) and the roasted beans obtained in step b) are extracted separately in step c) to obtain two separate coffee extracts, the two coffee liquid extracts may be mixed before drying, or they may be dried separately and subsequently mixed in dry form, e.g. as powders, e.g. obtained by spray drying or freeze drying.

In an embodiment, the invention relates to a method of producing a coffee composition, the method comprising;

a) roasting a first type of green coffee beans to a roast colour of between 60 and 120 CTN;

b) roasting a second type of green coffee beans to a roast colour of between 30 and 100 CTN;

c) extracting the roasted beans obtained in step a) and the roasted beans obtained in step b) with water (for example to produce aqueous coffee extracts that may be further processed into pure soluble coffee) at a temperature of between 140 and 300° C.; wherein the roast colour of the roasted first type of coffee beans is at least 20 CTN higher than the roast colour of the roasted second type of coffee beans, and the green second type of coffee beans are roasted for a period at least 5 minutes longer than the period for which the green first type of coffee beans are roasted; and wherein the first type of green coffee beans is from a different origin and/or a different coffee species than the second type of green coffee beans.

For example the invention may relate to a method of producing a coffee composition, the method comprising;

a) roasting green Arabica coffee beans to a roast colour of between 60 and 120 CTN;

b) roasting green Robusta coffee beans to a roast colour of between 30 and 100 CTN;

c) extracting the roasted Arabica beans obtained in step a) and the roasted Robusta beans obtained in step b) with water (for example to produce aqueous coffee extracts that may be further processed into pure soluble coffee) at a temperature of between 140 and 300° C.; wherein the roast colour of the roasted Arabica coffee beans is at least 20 CTN higher than the roast colour of the roasted Robusta beans, and the green Robusta beans are roasted for a period at least 5 minutes longer than the period for which the green Arabica beans are roasted.

In another embodiment, the invention relates to method of producing a liquid coffee extract comprising at least 1.5% by weight of soluble coffee solids, or a dried coffee extract, the method comprising: a) roasting a first type of green coffee beans to a roast colour of between 60 and 120 CTN; b) roasting a second type of green coffee beans to a roast colour of between 30 and 100 CTN; c) extracting the roasted beans obtained in step a) and the roasted beans obtained in step b) with water; and optionally drying the coffee extract obtained in step c) to produce a dry soluble coffee product; wherein the roast colour of the roasted coffee beans obtained in step a) is at least 20 CTN higher than the roast colour of the roasted coffee beans obtained in step b), and the second type of green beans are roasted for a period at least 5 minutes longer than the period for which the first type of green coffee beans are roasted; and wherein the first type of green coffee beans is from a different origin and/or a different coffee species than the second type of green coffee beans.

For example the invention may relate to a method of producing a liquid coffee extract comprising at least 1.5% by weight of soluble coffee solids, or a dried coffee extract, the method comprising: a) roasting green Arabica coffee beans to a roast colour of between 60 and 120 CTN; b) roasting green Robusta coffee beans to a roast colour of between 30 and 100 CTN; c) extracting the roasted Arabica beans obtained in step a) and the roasted Robusta beans obtained in step b), with water; and optionally drying the coffee extract obtained in step c) to produce a dry soluble coffee product; wherein the roast colour of the roasted Arabica coffee beans is at least 20 CTN higher than the roast colour of the roasted Robusta beans, and the green Robusta beans are roasted for a period at least 5 minutes longer than the period for which the green Arabica beans are roasted.

In an embodiment, the method of the invention relates to a method for producing the coffee composition of the invention.

### EXAMPLES

### Example 1: Correlation between CTN and Hunter L Units for Roast Bean Colour

Roast bean colour measured in Hunter L units with the ColorQuest instrument from Hunterlab was compared to roast bean colour measured in CTN units with the ColorTest instrument from Neuhaus Neotec.

Hunter L values: A ColorQuest spectrophotometer using a continuous 30 W lamp and a diffraction lens detection was used. The measurements were carried out by CIE D65 illuminant and a 10°-observer function. The geometry of the ColorQuest is 45°/0° with a 95 mm aperture. The data are given as Hunter L values. Further description of the Hunter L colour measurement method can be found in WO 01/67880 and references therein.

CTN values: A Neuhaus Neotec Colourtest instrument was used to measure CTN roast colour.

Colombian coffee beans were roasted to 5 different roast colors, determined by the ColorTest from Neuhaus Neotec as 62, 74, 80, 94 and 102 CTN. The coffee beans were ground on a Ditting grinder at setting 5.5 and directly measured on the ColorQuest.

The following linear correlation between CTN and Hunter L values was found:

Hunter L=0.136·CTN+6.04

### Example 2: 45% Arabica/55% Robusta

### Production of Reference Sample

A 170 kg charge of 20% dry processed green Arabica, 25% wet processed green Arabica and 55% green Robusta coffee beans was blended and then roasted for 10 minutes on a Probat RT1000 roaster to an end point temperature of 234° C. and a roast colour of 63 CTN. The roasted coffee was ground and extracted with hot water with a maximum temperature of 180° C. The extract was dried to produce dried granules of soluble coffee.

### Production of Test Sample

A 65 kg charge of 44% dry processed green Arabica and 56% wet processed green Arabica was roasted for 2 minutes on a Neuhaus RFB150 roaster to an end point temperature of 227° C. and a roast colour of 85 CTN. A 130 kg charge of 100% green Robusta coffee beans was roasted for 10 minutes on Neuhaus RFB150 roaster to an end point temperature of 246° C. and a roast colour of 45 CTN. The green coffees were of the same quality and lot as the reference. The Arabica and Robusta roasted coffees were mixed so that the composition of the variant had the same percentage of each coffee origin as the reference. The roast colour of the mixed Arabica and Robusta roasted coffees was the same value as the reference. The mixture was ground and extracted with hot water with a maximum temperature of 180° C. The extract was dried to produce dried granules of soluble coffee.

The reference and variant coffees were compared to each other in black preparation and with milk. The test sample demonstrated significantly higher overall intensity, roasty and acid flavour attributes as black, and higher intensity, coffeeness, roasty and bitter flavour attributes in milk, than the reference sample.

### Example 3: 50% Arabica/50% Robusta

### Production of Reference Sample

A 155 kg charge of 50% wet processed green Arabica and 50% green Robusta coffee beans was blended and then roasted for 9.4 minutes on a Neuhaus Neotec RFB150 roaster to an end point temperature of 231° C. and a roast colour of 69 CTN. The roasted mixture was ground and extracted with hot water with a maximum temperature of 180° C. The extract was dried to produce dried granules of soluble coffee.

### Production of Test Sample

A 65 kg charge of 100% wet processed green Arabica coffee beans was roasted for 138 seconds on a Neuhaus RFB150 roaster to an end point temperature of 228° C. and a roast colour of 84 CTN. A 130 kg charge of 100% green Robusta coffee beans was roasted for 10 minutes on Neuhaus RFB150 roaster to an end point temperature of 242° C. and a roast colour of 55 CTN. The green coffees were of the same quality and lot as the reference. The Arabica and Robusta roasted coffees were mixed so that the composition of the variant had the same percentage of each coffee origin as the reference. The roast colour of the mixed Arabica and Robusta roasted coffees was the same value as the reference. The mixture was ground and extracted with hot water with a maximum temperature of 180° C. The extract was dried to produce dried granules of soluble coffee.

The reference and variant coffees were compared to each other in black preparation and with milk.

### Black

In cup preparation:

1.6 g dry soluble coffee/100 ml water

100 mL Hot water at 80° C.

### With Milk

In cup preparation:

1.3 g dry soluble coffee/100 ml liquid (70 mL water+30 mL milk 1.5% fat)

100 mL Hot water at 80° C.

The test sample demonstrated significantly higher overall intensity, coffeeness, roasty, fruity and acid flavour and juicy texture attributes in black, and higher overall intensity, coffeeness, roasty and bitter flavour attributes in milk, as compared to the reference sample.

### Example 4: 66% Arabica/34% Robusta

### Production of Reference Sample

A 155 kg charge of 46% wet processed green Arabica coffee beans, 20% dry processed green Arabica coffee beans and 34% green Robusta coffee beans was blended and then roasted for 10 minutes on a Neuhaus Neotec RFB150 roaster to an end point temperature of 232° C. and a roast colour of 70 CTN. The roasted mixture was ground and extracted with hot water with a maximum temperature of 180° C. The extract was dried to produce dried granules of soluble coffee.

### Production of Test Sample

A 80 kg charge of 70% wet processed green Arabica coffee beans and 30% dry processed green Arabica coffee beans was roasted for 5 minutes on a Probat RT1000 roaster to an end point temperature of 217° C. and a roast colour of 87 CTN. A 170 kg charge of 100% green Robusta coffee beans was roasted for 15 minutes on a Probat RT1000 roaster to an end point temperature of 241° C. and a roast colour of 55 CTN. The green coffees were of the same quality and lot as the reference. The Arabica and Robusta roasted coffees were mixed so that the composition of the variant had the same percentage of each coffee origin as the reference. The roast colour of the mixed Arabica and Robusta roasted coffees was the same value as the reference. The mixture was ground and extracted with hot water with a maximum temperature of 180° C. The extract was dried to produce dried granules of soluble coffee.

The reference and variant coffees were compared to each other in black preparation—in this case monadic profiling.

In cup preparation:

1.6 g soluble coffee/100 ml water

100 mL Hot water at 80° C.

The test sample showed a significantly increased fruity, winey, acid and juicy flavour and reduced rubber flavour compared to the reference.

### Example 5: 45% Arabica/55% Robusta (Comparative Example)

### Production of Reference Sample

A 170 kg charge of 20% dry processed green Arabica coffee beans, 25% wet processed green Arabica coffee beans and 55% green Robusta coffee beans was blended and then roasted for 10 minutes on a Probat RT1000 roaster to an end point temperature of 234° C. and a roast colour of 63 CTN. The roasted coffee was ground and extracted with hot water with a maximum temperature of 180° C. The extract was dried to produce dried granules of coffee.

### Production of Test Sample

A 80 kg charge of 45% dry processed green Arabica coffee beans and 55% wet processed green Arabica coffee beans was roasted for 5 minutes on a Probat RT1000 roaster to an end point temperature of 223° C. and a roast colour of 67 CTN. A 170 kg charge of 100% green Robusta coffee beans was roasted for 15 minutes on Probat RT1000 roaster to an end point temperature of 239.8° C. and a roast colour of 60 CTN. The green coffees were of the same quality and lot as the reference. The Arabica and Robusta roasted coffees were mixed so that the composition of the variant had the same percentage of each coffee origin as the reference. The roast colour of the mixed Arabica and Robusta roasted coffees was the equivalent (64 vs 63 CTN) value as the reference. The mixture was ground and extracted with hot water with a maximum temperature of 180° C. The extract was dried to produce dried granules of soluble coffee.

The reference and variant coffees were compared to each other in black preparation and with milk. Very limited differences were found between the reference and the test sample.

### Example 6: 45% Arabica/55% Robusta (Comparative Example)

### Production of Reference Sample

A 170 kg charge of 20% dry processed green Arabica coffee beans, 25% wet processed green Arabica coffee beans and 55% Robusta coffee beans was blended and then roasted for 10 minutes on a Probat RT1000 roaster to an end point temperature of 234° C. and a roast colour of 63 CTN. The roasted coffee was ground and extracted with hot water with a maximum temperature of 180° C. The extract was dried to produce dried granules of soluble coffee.

### Production of Test Sample

A 65 kg charge of 45% dry processed green Arabica coffee beans and 55% wet processed green Arabica coffee beans was roasted for 2 minutes on a Neuhaus Neotec RFB150 roaster to an end point temperature of 230° C. and a roast colour of 73 CTN. A 1300 kg charge of 100% green Robusta coffee beans was roasted for 10 minutes on a Neuhaus Neotec RFB150 roaster to an end point temperature of 241.7° C. and a roast colour of 55 CTN. The green coffees were of the same quality and lot as the reference. The Arabica and Robusta roasted coffees were mixed so that the composition of the variant had the same percentage of each coffee origin as the reference. The roast colour of the mixed Arabica and Robusta roasted coffees was the equivalent (63 CTN) value as the blend before roast reference. The mixture was ground and extracted with hot water with a maximum temperature of 180° C. The extract was dried to produce dried granules of soluble coffee.

The reference and variant coffees were compared to each other in black preparation and with milk. No differences were found between the reference and the test sample when tasted black and limited differences when tasted white.

### Example 7

### Flavour Compound Analysis

A 50%/50% blend of wet processed green Arabica coffee beans and green Robusta coffee beans was mixed prior to roasting and roasted to three different roast colours 100, 75 and 55 CTN using a fixed time of 15 minutes in a Probat RT1000 roaster (Trials 1, 8 and 9 in Table 1). Beans of the same green Arabica and Robusta coffees were separately roasted for varying time and to varying colours as detailed in Table 1 (Trials 2-7 and 10-13) and the separately roasted beans were mixed in equal amounts. Dried soluble coffee was produced from each sample by the method described in example 2. Absolute contents (mg/kg of soluble coffee solids) of key aroma markers (Table 2) were determined in-cup using isotopically labelled standards in conjunction with solid phase microextraction and gas chromatography-mass spectrometry (SPME-GC-MS/MS) analysis.

Quantitative evaluation of astringency taste marker N-caffeoyl-tryptophan was performed by liquid chromatography tandem mass spectrometry (LCMS/MS) using rosmarinic acid for standardization, and concentrations were calculated in mg of compound expressed as rosmarinic acid equivalent per kg of soluble coffee solids.

Ratios of analysed compounds were calculated based on the obtained concentrations in mg/kg of soluble coffee solids.

### a. Aroma Compound Analysis

### Sample Preparation

The coffee sample (0.5 g) was placed in glass bottle Schott 100 mL, dissolved in 50 mL of ultrapure water and stirred for 5 min using a magnetic stirrer. The labelled standards ([2H5]-2,3-pentanedione, [2H3]-4-ethylguaiacol, [2H4]-furfural, [2H4]-(E)-β-damascenone) have been added, the sample was stirred for 20 minutes, and an aliquot of sample (7 ml) was transferred into silanised glass vials that were sealed (standard 20 mL vials used for headspace/SPME analysis).

### Extraction of Aroma

The sample was equilibrated for 60 min at room temperature. Aroma compounds were then extracted from the headspace by solid phase microextraction (SPME) at 40° C. during 10 min (2 cm fiber, 50/30 μm StableFlex, coated with PDMS/DVB/Carboxen; Supelco, Buchs, Switzerland), and thermally desorbed into the split-splitless injector (in split-mode; split of 2) heated at 240° C. for 10 min.

### GC-MS/MS Analysis of 2,3-pentanedione, 4-ethylguaiacol, furfural, and (E)-β-damascenone

Separation was carried out on a 60 m×0.25 mm×0.25 μm polar DB-624UI column (Agilent, Basel, Switzerland) using an Agilent 7890B gas chromatograph (Agilent, Basel, Switzerland). Helium was used as carrier gas with a constant flow of 1.2 mL/ min. Following oven program was applied: initial temperature of 40° C. was held for 6 min, then raised to 240° C. at 6° C./min, and final temperature held for 10 min. Mass spectrometry was performed on an Agilent 7010 Triple Quad mass spectrometer (Agilent, Basel, Switzerland). Chromatograms were processed using the Agilent MassHunter software.

### b. Taste Compound Analysis

### Sample Preparation

40 mg of sample were weighed into a 20 mL volumetric flask and filled up with ultrapure water after addition of 200 μL of a 150 mg/L solution of rosmarinic acid as internal standard.

### LC-MS/MS Analysis of N-caffeoyl-tryptophan

To perform the chromatography, an Agilent 1200 series HPLC system (Agilent, Basel, Switzerland) was used. 2 μL of the sample were injected for the analysis after membrane filtration in a triplicate determination onto a Kinetex Phenyl-Hexyl 100 mm×3.00 mm×5 μm column (Phenomenex, Aschaffenburg, Germany), using 0.1% aqueous formic acid (A) and acetonitrile (B) as mobile phase. At flow rate of 0.5 mL/min, the following gradient was applied: in 20 min from 10% to 20% B, up to 31.5% in 15 min, then in 2 min to 100% B kept for 4 min before going to starting conditions in 2 min kept for 7 min. The chromatographic system was coupled with an AB Sciex QTRAP 4000 mass spectrometer (AB Sciex, Darmstadt, Germany), applying the following mass transitions: N-caffeoyl-tryptophan 367.0 to 163.0 (with DP: 40V, EP: 10V, CE: 25V, CXP: 10V), rosmarinic acid 361.0 to 163.0 (with DP: 40V, EP: 10V, CE: 52V, CXP: 10V). Chromatograms were processed using MultiQuant as software.

TABLE 1
Chemical analysis of aroma compounds and N-caffeoyl-tryptophan (example 7).

| | | | | | | Ratios | | |
|---|---|---|---|---|---|---|---|---|
| | | | | | | 2,3- | | N-caffeoyl- |
| | Roast Colour | | Roast Time | | Avg | pentanedione/ | furfural/ | tryptophan/ |
| | CTN | | [min] | | roast | 4- | (E)-β- | 4- |
| Trial | ARA | ROB | ARA | ROB | colour | ethylguaiacol | damascenone | ethylguaiacol |
| 1 | 55 | | 15 | | 55 | 2.40 | 147 | 1765 |
| 2 | 55 | 100 | 15 | 15 | 77.5 | 6.91 | 203 | 10119 |
| 3 | 55 | 75 | 15 | 15 | 65 | 3.90 | 177 | 3230 |
| 4 | 75 | 55 | 15 | 15 | 65 | 4.02 | 225 | 1650 |
| 5 | 75 | 100 | 15 | 15 | 87.5 | 14.73 | 265 | 16457 |
| 6 | 100 | 55 | 15 | 15 | 77.5 | 5.07 | 296 | 2182 |
| 7 | 100 | 75 | 15 | 15 | 87.5 | 8.51 | 321 | 5569 |
| 8 | 75 | | 15 | | 75 | 8.25 | 208 | 8008 |
| 9 | 100 | | 15 | | 100 | 34.88 | 352 | 45435 |
| 10 | 100 | 55 | 5 | 15 | 77.5 | 6.09 | 451 | 2294 |
| 11 | 75 | 55 | 5 | 15 | 65 | 6.50 | 440 | 2007 |
| 12 | 100 | 55 | 2 | 15 | 77.5 | 6.44 | 531 | 2164 |
| 13 | 75 | 55 | 2 | 15 | 65 | 5.99 | 465 | 1913 |

ARA = Arabica coffee beans, ROB = Robusta coffee beans.

TABLE 2
Chemical analysis of aroma compounds and N-caffeoyl-tryptophan (example 7).

| | | Concentration flavor compound | | | | |
|---|---|---|---|---|---|---|
| | 2,3- | 2,3- | 4- | | (E)-β- | N-caffeoyl- |
| Trial | pentanedione^{a} | butanedione^{a} | ethylguaiacol^{a} | furfural^{a} | damascenone^{a} | tryptophan^{b} |
| 1 | 10.57 | 35.51 | 4.40 | 11.89 | 0.081 | 7761 |
| 2 | 13.51 | 37.34 | 1.95 | 16.35 | 0.080 | 19776 |
| 3 | 13.26 | 39.43 | 3.40 | 14.32 | 0.081 | 10990 |
| 4 | 17.73 | 40.11 | 4.41 | 22.37 | 0.100 | 7279 |
| 5 | 18.96 | 37.08 | 1.29 | 25.65 | 0.097 | 21185 |
| 6 | 21.41 | 37.69 | 4.22 | 29.99 | 0.101 | 9206 |
| 7 | 22.08 | 36.23 | 2.59 | 32.41 | 0.101 | 14443 |
| 8 | 16.33 | 38.24 | 1.98 | 19.67 | 0.094 | 15853 |
| 9 | 22.72 | 31.92 | 0.65 | 32.49 | 0.092 | 29602 |
| 10 | 25.06 | 50.32 | 4.11 | 44.22 | 0.098 | 9435 |
| 11 | 25.69 | 58.30 | 3.95 | 38.23 | 0.087 | 7932 |
| 12 | 25.88 | 59.82 | 4.02 | 46.41 | 0.087 | 8703 |
| 13 | 25.06 | 58.77 | 4.18 | 41.73 | 0.090 | 7997 |

ARA = Arabica coffee beans, ROB = Robusta coffee beans.
^{a}concentration expressed as mg of compound per kg of soluble coffee solids
^{b}concentration as mg of compound expressed as rosmarinic acid equivalent per kg of soluble coffee solids

The samples were also tasted in black preparations. The mixtures of roasted beans was ground and extracted with hot water with a maximum temperature of 180° C. The extract was dried to produce dried granules of soluble coffee. Roasting time was found to play an important role, independent of roasting colour. The beans in trial 4 and trial 11 were roasted to the same roast colours, but in trial 11 the Arabica beans were roasted 10 minutes shorter than the Robusta beans. This preserved significantly the Arabica character such as acid and juicy flavour. The reduced roasting time applied on the Arabica beans also prevented the degradation of important compounds such as 2,3-butanedione, 2,3-pentanedione, and furfural. The effect of roasting time was also observed comparing trial 6 with trial 12 where the Arabica beans were roasted for 13 minutes shorter than the Robusta beans. Trial 12 produced a coffee with increased acid and juicy flavour. Similarly, the reduced roasting time for the Arabica beans significantly preserved desirable compounds like 2,3-butanedione, 2,3-pentanedione, and furfural.

1. A coffee composition comprising furfural and (E)-β-damascenone wherein the ratio of concentrations of furfural to (E)-β-damascenone is from 400 to 1000.

2. The coffee composition according to claim 1 comprising 4-ethylguaiacol and 2,3-pentanedione wherein the ratio of concentrations of 2,3-pentanedione to 4-ethylguaiacol is from 5 to 20.

3. The coffee composition according to claim 1 comprising N-caffeoyl-tryptophan and 4-ethylguaiacol wherein the ratio of concentrations of 4-ethylguaiacol to N-caffeoyl-tryptophan is from 1500 to 3000.

4. The coffee composition according to claim 1 comprising at least 20 wt. % coffee solids originating from Robusta beans as a percentage of total coffee solids.

5. The coffee composition according to claim 1 comprising at least 45 mg of 2,3-butanedione per kg of soluble coffee solids.

6. A method of producing a coffee composition, the method comprising;
a) roasting a first type of green coffee beans to a roast colour of between 60 and 120 CTN;
b) roasting a second type of green coffee beans to a roast colour of between 30 and 100 CTN;
c) extracting the roasted beans obtained in step a) and the roasted beans obtained in step b) with water;
wherein the roast colour of the roasted beans obtained in step a) is at least 20 CTN higher than the roast colour of the roasted beans obtained in step b), and the second type of beans are roasted for a period at least 5 minutes longer than the period for which the first type of beans are roasted;
and wherein the first type of green coffee beans is from a different origin and/or a different coffee species than the second type of green coffee beans.

7. The method of claim 6, wherein the first type of green coffee beans constitute between 20% and 80% by weight of the total amount of green coffee beans subjected to the method.

8. The method of claim 6 wherein the first type of green beans are roasted for a period of between 1 and 10 minutes in step a).

9. The method of claim 6 wherein the second type of green beans are roasted for a period of between 6 and 20 minutes in step b).

10. The method of claim 6 wherein the roasted beans obtained in step a) and the roasted beans obtained in step b) are extracted at a temperature of between 140 and 300° C. in step c).

11. The method of claim 6 wherein the roasted beans obtained in step a) and/or the roasted beans obtained in step b) are ground before the extraction in step c)

12. The method of claim 6 wherein the roasted beans obtained in step a) and the roasted beans obtained in step b) are mixed before the extraction in step c).

13. The method of claim 6 wherein the roasted beans obtained in step a) and/or the roasted beans obtained in step b) are extracted separately in step c) to obtain two separate coffee extracts which are subsequently mixed.

14. The method of claim 6 wherein the extract(s) obtained in step c) is/are dried to produce a dry soluble coffee product.

15. The method of claim 6 wherein the first type of green coffee beans are Arabica beans and the second type of green coffee beans are Robusta beans.
